(19) United States
(12) Patent Application Publication
(10) Pub. No.: US 2016/0162995 A1
(43) Pub. Date: Jun. 9, 2016

(54) METHOD AND SYSTEM FOR DUPLICATE INVOICE ENTRY DETECTION

(71) Applicant: Siemens Technology and Services Pvt. Ltd., Mumbai (IN)

(72) Inventors: Naveen Kumar CHUVATA PUDIYAVEETIL, Bangalore (IN); Sreedhar NAYANI, Bangalore (IN); Vinoy VARGHESE, Bangalore (IN)

(21) Appl. No.: 14/560,092

(22) Filed: Dec. 4, 2014

(51) Int. Cl. G06Q 40/00

(52) U.S. Cl. CPC G06Q 40/12

(57) ABSTRACT

A method is disclosed for detection of potential duplicate invoice entries in an invoice database, the invoice database including of invoice entries having information tags. The method includes extracting a current invoice data from the in-voice database; selecting a combination criteria, the combination criteria including a combination of the information tags; comparing the current invoice data with the invoice entries of the invoice database based on the combination criteria; and identifying and notifying when one or more potential duplicate invoice entries have been identified. The information tag comprises of vendor identification, invoice number, invoice amount, invoice date and numeric invoice and the combination criteria comprises of a special combination of selected information tags.

### FIELD

The present technology generally relates to a method and a system for detection or identification of duplicate invoice entries in an invoice database.

### BACKGROUND

Monitoring, controlling and tracking of duplicate invoice entries in a database containing invoices is diffi-cult and is many times replete with errors. There can be instances of incorrect data entries into the invoice database, routine keying errors, issues with processing of data for example, ‘0’ and ‘o’ can get mixed up, errors due to vendor behaviour and also making an entry into the database a second time due to non-availability of certain information earlier. All these factors together cause incorrect entries to be en-tered into the database and in future resulting in instances of duplicate invoice entries making their way into the invoice database. The problem with having duplicate entries in the invoice database is that it leads to double payment for a single invoice.

There are known ERP systems that exercise a certain degree of control while processing invoices and these ERP systems attempt to identify duplicate entries of invoices into a database however, there are issues faced with such ERP systems. Every data entry of invoice will have a few information fields, information tags or parameters, say vendor ID, invoice number, invoice date, amount etc. With these ERP systems, if the processor updates more than one record with the same vendor ID, invoice number, invoice date and amount for the same company code, the ERP system throws a warning. But this control alone is not sufficient as the processor may modify any one of these information fields or parameters either intentionally or erroneously which may override the warning. In some ERP systems this control is not consistant. Some of these controls are overridden when the invoice data is updated into ERPs through Electronic Data Interface (EDI). Directly updating the invoice data into ERP database using EDI overrides the validation that may be present in the front end tool of the ERP which could detect duplicate entries. In some cases, a vendor may send an invoice with different invoice numbers or date or amount or billed to different enti-ties of a company. This makes the control weak.

Another kind of control exercised in ERP systems for detection of duplicate entries is to introduce hard stops or soft stops when a duplicate entry is identified. This slows down the system as more time is needed for processing. To reduce the slowing of the ERP system only critical criteria is configured for duplicate entry detection; hence the system is not without its flaws.

Prior art U.S. Pat. No. 8,630,996 is of interest with respect to this patent application. It discloses identification of duplicate entries in a historical database. The disclosed method comprises of the steps of extracting historical data from a historical database according to predeter-mined extraction criteria, searching for one or more potential duplicate entries in the historical data according to a portion of selection criteria used for generating the historical database, and submitting a notification when one or more potential duplicate entries have been identified.

Prior art U.S. Pat. No. 8,832,041 is also of interest with respect to this patent application. It discloses a system and method for identifying duplicate entries within a set of entries. Method comprises a first step of receiving the set of entries. Each entry comprises set of field values associated with field types. The set of field values comprises non-blank field values. Next the method comprises a step of calculating hash value for plural ones of the non-blank field values in at least subset of the set of entries. The next step comprises of a step of determining that hash value of first field value in first entry corresponds to hash value of second field value in second entry. The first field value and the second field value comprise non-blank field values. The method then comprises determining that each non-blank field value in the first entry does not conflict with each non-blank field value in the second entry. And finally the method includes providing an indication that the first entry and the second entry comprise duplicate entries.

### SUMMARY

The inventors have recognized that there still ex-ists a need for a simpler and a robust method for detecting and identifying duplicate invoice entries in an invoice database which is able to correctly identify duplicate invoice entries even if one or more of the information fields, information tags or parameters have been changed, either intentionally or erroneously and does not slow down the system.

At least one embodiment of the present invention addresses the above mentioned need by providing an efficient and a robust method and system for detection of potential duplicate entries in an invoice database.

At least one embodiment of the invention is di-rected to a method for detection of potential duplicate invoice entries in an invoice database, wherein the invoice database comprises of invoice entries having information tags. The method comprises a first step of extracting a current invoice data from the in-voice database. The second step comprises of selecting a combination criteria, wherein the combination criteria comprises of a combination of the information tags. The next step is of comparing the current invoice data with the invoice entries of the invoice database based on the combination criteria. The final step comprises of identifying and notifying when one or more potential duplicate invoice entries have been identified. The invoice database is regularly updated at scheduled intervals.

In an embodiment of the system for detection of potential duplicate invoice entries in an invoice database, the system comprises a memory and a processor coupled to the memory. The processor is programmed to extract a current invoice data from the invoice database, select a combination criteria, compare the current invoice data with the invoice entries of the invoice database based on the combination criteria, identify and notify when one or more potential duplicate invoice entries have been identified. The combination criteria comprises of a combination of the information tags. The embodiment of the system further comprises displaying one or more potential duplicate invoice entries on a display screen.

In yet another embodiment, a non-transitory computer-readable storage medium comprising computer instructions is disclosed. The computer instructions are for extracting a current invoice data from the in-voice database, selecting a combination criteria, comparing the current invoice data with the invoice entries of the invoice database based on the combination criteria and finally, identifying and notifying when one or more potential duplicate invoice entries have been identified. The combination criteria comprises of a combination of the information tags.

### BRIEF DESCRIPTION OF THE DRAWINGS

The above-mentioned and other features of the invention will now be addressed with reference to the accompanying drawings of the present invention. The illustrated embodiments are intended to illustrate, but not limit the invention. The drawings contain the following figures, in which like numbers refer to like parts, throughout the description and drawing.

FIG. 1 shows a flowchart containing the steps according to the disclosed method.

FIG. 2 displays an example invoice database.

FIG. 3 is a schematic diagram depicting the system for detection of potential duplicate invoice entries in the invoice database.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have addi-tional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, spec-ify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, elec-trical, or magnetic signals capable of being stored, trans-ferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Cen-tral Processing Units (CPUs), digital signal processors (DSPs), application-specific-integrated-circuits, field pro-grammable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementa-tion.

It should be borne in mind, however, that all of these and similar terms are to be associated with the appro-priate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the invention is di-rected to a method for detection of potential duplicate invoice entries in an invoice database, wherein the invoice database comprises of invoice entries having information tags. The method comprises a first step of extracting a current invoice data from the in-voice database. The second step comprises of selecting a combination criteria, wherein the combination criteria comprises of a combination of the information tags. The next step is of comparing the current invoice data with the invoice entries of the invoice database based on the combination criteria. The final step comprises of identifying and notifying when one or more potential duplicate invoice entries have been identified. The invoice database is regularly updated at scheduled intervals.

In an embodiment of the present invention the method further comprises a step of displaying one or more potential duplicate invoice entries on a display screen. Displaying the potential duplicate entries would enable a user to manually verify and evaluate the entries and check which entries are to be retained and which are to be deleted.

In another embodiment of the method the information tag comprises of vendor identification, invoice number, invoice amount, invoice date and numeric invoice. Further in the embodiment the combination criteria comprises of any one set from the set of vendor identification, invoice number, invoice amount; vendor identification, invoice number, invoice date; vendor identification, invoice number; vendor identification, invoice date, invoice amount; invoice number, invoice date, invoice amount; vendor identification, numeric invoice; numeric invoice, invoice amount; vendor identification, invoice amount; invoice date, invoice amount; vendor identification, numeric invoice, invoice date, invoice amount; vendor identification, numeric invoice, invoice amount or vendor identification, numeric invoice, invoice date. The information tag contains vital information about the invoice entry. The combination criteria acts as a means through which duplicate invoice entries can be found out. Instead of matching all the information tags for the current invoice data, the combination criteria provides only few of the information tags to be compared to identify duplicate invoice entries. This reduces the time taken to detect duplicate invoice entries.

In a further embodiment, the combination criteria is a default combination criteria. In other words the same combination criteria is used for comparison of all current invoice data with the invoice entries of the invoice database. For example, when the default combination criteria is set as vendor identification, invoice number, invoice amount, the method uses this combination criteria only for all com-parisons of the current invoice data with the invoice entries of the invoice database. In a further embodiment this default combination criteria can be reset and changed accordingly by the user based on his or her requirement.

In yet another embodiment, the method comprises a step of saving the potential duplicate invoice entries in a database table. This helps in fetching the necessary information about the duplicate entries in future as and when desired. Such information stored in database tables is also useful for studying the invoice database and to study the ac-curacy of the data. This feature enables to categorize the root cause of the duplicate invoice entry and take corrective and preventive action accordingly. The information stored in database tables can be further converted and stored in various file formats, for example in the form of Excel sheets, for further customization.

In another embodiment, the method comprises a step of providing a role-based access for a user to the invoice database. The user is assigned a role and each role is granted access to only a certain portion of the invoice database. In other words, each user is granted access to only a certain portion of the database based on the role that is assigned to that user. In a further embodiment the role is any one of an auditor, approver, administrator or notification contact. In an exemplary scenario the potential duplicate invoice entries are displayed on a screen to a user who is assigned the role of an auditor. When the auditor verifies the invoice entries and marks a record as a duplicate invoice entry from the current invoice data, the method further involves generation of notification with information on suspected duplicates invoice entries, for example, via email, to a user who is assigned the role of an approver. The approver then verifies the au-dited result and further takes preventive or corrective action and updates the same in the invoice database. According to this embodiment the auditor and the approver will be able to modify only those information tags or portion of the database to which they have access to. This will ensure data integrity.

In the above example scenario if no action was taken by the approver, the method further constitutes a step of sending escalation emails to approver's managers or the con-cerned person as per set timelines.

In an embodiment of the system for detection of potential duplicate invoice entries in an invoice database, the system comprises a memory and a processor coupled to the memory. The processor is programmed to extract a current invoice data from the invoice database, select a combination criteria, compare the current invoice data with the invoice entries of the invoice database based on the combination criteria, identify and notify when one or more potential duplicate invoice entries have been identified. The combination criteria comprises of a combination of the information tags. The embodiment of the system further comprises displaying one or more potential duplicate invoice entries on a display screen.

In an example embodiment, the system uses advanced RDBMS with indexing for a faster and more efficient system response.

In yet another embodiment, a non-transitory computer-readable storage medium comprising computer instructions is disclosed. The computer instructions are for extracting a current invoice data from the in-voice database, selecting a combination criteria, comparing the current invoice data with the invoice entries of the invoice database based on the combination criteria and finally, identifying and notifying when one or more potential duplicate invoice entries have been identified. The combination criteria comprises of a combination of the information tags.

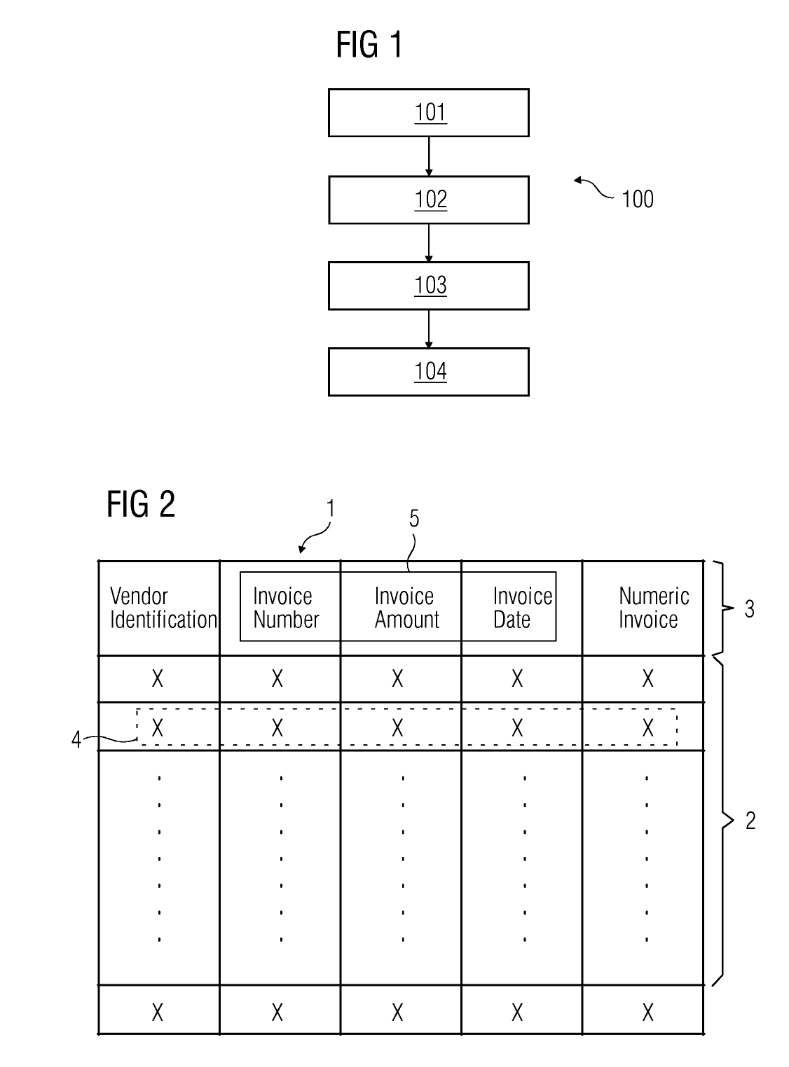

According to FIG. 1 the method 100 for detection of potential duplicate in-voice entries in an invoice database 1 disclosed in the flowchart shows a first step 101 of extracting a current invoice data 4 from the invoice database 1. The second step 102 of the method 100 comprises selection of a combination criteria 5. The next step 103 as shown in FIG. 1 comprises of comparing the current invoice data 4 with the invoice entries 2 of the invoice database 1 based on the combination criteria 5. The final step 104 comprises of identifying and notifying when one or more potential duplicate invoice entries have been identified.

According to FIG. 2 the invoice database 1 comprises of invoice entries 2 and information tag 3. The information tag 3 further comprises of vendor identification, invoice number, invoice amount, invoice date and numeric invoice. The invoice data 4 is selected or extracted portion of the invoice database 1 comprising of one or more invoice entries 2. The combination criteria 5 comprises of any one set from vendor identification, invoice number, invoice amount; vendor identification, invoice number, invoice date; vendor identification, invoice number; vendor identification, invoice date, invoice amount; invoice number, invoice date, invoice amount; vendor identification, numeric invoice; numeric invoice, invoice amount; vendor identification, invoice amount; invoice date, invoice amount; vendor identification, numeric invoice, invoice date, invoice amount; vendor identification, numeric invoice, invoice amount or vendor identification, numeric invoice, invoice date.

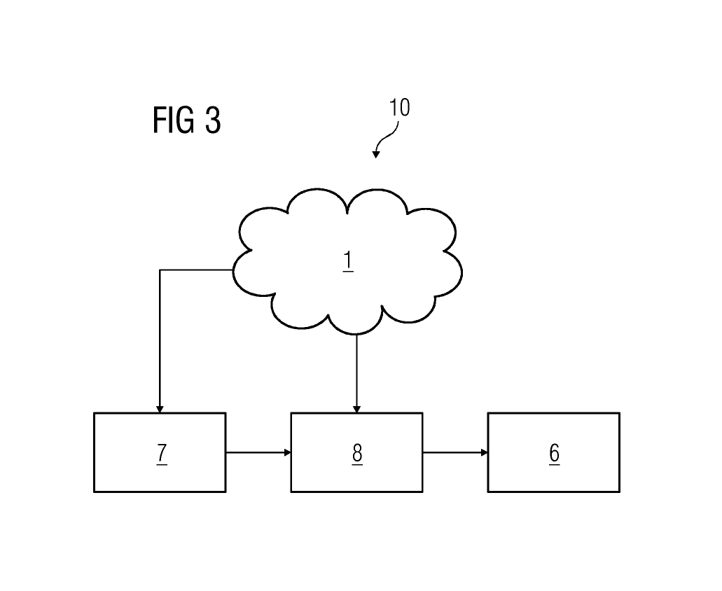

According to the system 10 for detection of potential duplicate invoice entries in an invoice database 1 as shown in FIG. 3 the system 10 comprises of a memory 7, a processor, a display unit 8 and the invoice database 1. The processor 8 is coupled to the memory 7. The system 10 further comprises of a display unit 6 for displaying the potential duplicate entries. The processor 8 is configured to extract the current invoice data 4 from the invoice database 1, select a combination criteria 5, compare the current invoice data 4 with the invoice entries 2 of the invoice database 1 based on the combination criteria 5, identify and notify when one or more potential duplicate invoice entries have been identified and finally display one or more potential duplicate invoice entries on a display screen 6.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form sepa-rate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or sub-stituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for per-forming the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cas-sette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be pro-vided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for detection of potential duplicate invoice entries in an invoice database, the invoice database including invoice entries having information tags, the method comprising:
extracting a current invoice data from the invoice database;
selecting a combination criteria, the combination criteria including a combination of the information tags;
comparing the current invoice data with the invoice entries of the invoice database based on the combination criteria; and
identifying and notifying when one or more potential duplicate invoice entries have been identified.

2. The method of claim 1, further comprising displaying one or more potential duplicate invoice entries on a display screen.

3. The method of claim 1, wherein the information tag comprises of vendor identification, invoice number, invoice amount, invoice date and numeric invoice and,
the combination criteria comprises of any one set from vendor identification, invoice number, invoice amount; vendor identification, invoice number, invoice date; vendor identification, invoice number; vendor identification, invoice date, invoice amount; invoice number, invoice date, invoice amount; vendor identification, numeric invoice; numeric invoice, invoice amount; vendor identification, invoice amount; invoice date, invoice amount; vendor identification, numeric invoice, invoice date, invoice amount; vendor identification, numeric invoice, invoice amount or vendor identification, numeric invoice, invoice date.

4. The method of claim 1, wherein the combination criteria is a default combination criteria.

5. The method of claim 1, further comprising saving the potential duplicate invoice entries in a database table.

6. The method of claim 1, further comprising providing a role-based access for a user to the invoice database, wherein the user is assigned a role and each role is granted access to a portion of the invoice database.

7. The method of claim 6, wherein the role is any one of an auditor, approver, administrator or notification contact.

8. A system for detection of potential duplicate invoice entries in an invoice database, the system comprising:
a memory; and
a processor coupled to the memory, the processor being programmed to:
extract a current invoice data from the invoice database,
select a combination criteria, the combination criteria including a combination of the information tags,
compare the current invoice data with the invoice entries of the invoice database based on the combination criteria,
identify and notify when one or more potential duplicate invoice entries have been identified, and
display one or more potential duplicate invoice entries on a display screen.

9. A non-transitory computer-readable storage medium, the storage medium comprising computer instructions for:
extracting a current invoice data from the in-voice database;
selecting a combination criteria, the combination criteria including of a combination of the information tags;
comparing the current invoice data with the invoice entries of the invoice database based on the combination criteria; and
identifying and notifying when one or more potential duplicate invoice entries have been identified.

10. The method of claim 2, wherein the information tag comprises of vendor identification, invoice number, invoice amount, invoice date and numeric invoice and,
the combination criteria comprises of any one set from vendor identification, invoice number, invoice amount; vendor identification, invoice number, invoice date; vendor identification, invoice number; vendor identification, invoice date, invoice amount; invoice number, invoice date, invoice amount; vendor identification, numeric invoice; numeric invoice, invoice amount; vendor identification, invoice amount; invoice date, invoice amount; vendor identification, numeric invoice, invoice date, invoice amount; vendor identification, numeric invoice, invoice amount or vendor identification, numeric invoice, invoice date.

11. The method of claim 2, wherein the combination criteria is a default combination criteria.

12. The method of claim 2, further comprising saving the potential duplicate invoice entries in a database table.

13. The method of claim 2, further comprising providing a role-based access for a user to the invoice database, wherein the user is assigned a role and each role is granted access to a portion of the invoice database.

14. The method of claim 13, wherein the role is any one of an auditor, approver, administrator or notification contact.
